(19) United States
(12) Patent Application Publication
(10) Pub. No.: US 2010/0262483 A1
(43) Pub. Date: Oct. 14, 2010

(54) ScSmartCard.com "Revolutionizing how the world eats fast food." Making fast food faster"

(75) Inventor: Daniel John McGurk, The Woodlands, TX (US)

Correspondence Address: Daniel J. McGurk, 18 Spiceberry Place, The Woodlands, TX, 77382, US

(73) Assignee: Daniel McGurk

(21) Appl. No.: 12/384,989

(22) Filed: Apr. 13, 2009

(51) Int. Cl. G06Q 30/00; G06Q 50/00

(52) U.S. Cl. 705/14.37; 705/15

(57) ABSTRACT

SmartCard is a personalized debit card that allows customers to alter their menu at the comfort of their own home while improving their fast food experience. Memory technology through a network linked to our website offers each individual a unique dining experience.

### A. BACKGROUND OF INVENTION

Self-Serving Kiosks have become popular within many industries such as banks, airports, and grocery stores. In addition, the fast food industry has recently become more interested in the prospect of improving their bottom line through Kiosks. In fact, a number of fast-food restaurants throughout the country (predominantly in California) have implemented automated service to customers. This process is done by creating software for a particular Kiosk, most notably IBM's Anyplace Kiosk. The creating company then would patent their software and attempt to distribute it. These Kiosks currently accept credit card and or cash depending on their capability. As of now, these Kiosks do not connect to a certain domain rather they just use the connection to process the payment. In other words, the Kiosk in your fast food restaurant is technically hooked up to the internet but lacks the ability to receive information.

The fact is that there is an enormous amount of parity in regards to the hardware and system engineering within this marketplace; any advancement in graphics or user ability is negated within months.

Our most notable problem with the current structure comes in the form of questioning the role of credit.

### B. BRIEF SUMMARY OF INVENTION

SmartCard believes in a personalization method that customers find valuable. Our website which will be linked through the Kiosk will allow multiple user -friendly options. Our thought process is that consumers value the ability to quickly and accurately receive their order.

In regards to credit, this was one of the most immediate reasons for application. Our analysis shows that families are increasingly using credit less. This occurs at the same time that parents are possibly worried that cash will not make it in the way of food. While irresponsible to give a minor a credit card or perhaps even cash, SmartCard allows for certain limitations to be placed on users. First of all, every purchase would be from a restaurant, but beyond that there are many limitations or benefits that would go into the “smart” or “memory” technology. See below for detailed description.

### C. DETAILED DESCRIPTION OF INVENTION

This whole concept is managed through a website (www.scsmartcard.com) that will allow customers to order their card, recharge their card, and personalize their ordering options for all different restaurants. By logging onto www.scsmartcard.com, you will be prompted with certain registration questions.

The username will be the person's email address while password is self-made.

The information one provides will make them eligible to receive a SmartCard in the mail. That individual SmartCard will have a serial number as well as a bar code. The serial number is for all customer information. For example, if a customer wants to check their balance via phone, they would provide a serial number and their password.

All transactions and purchases will take place using the bar code. The bar code will be an addition to current Kiosk models. Reading the bar codes will inevitably notify the Kiosk of your individual account.

Upon receiving a SmartCard in the mail, a customer will have many options to personalize their account settings. The changes that an individual makes on the website will show when they access their account at a Kiosk.

ScSmartCard.com would access your information via the Kiosk when a bar code is presented to the machine. Your account would have multiple options available along with many public relations discounts that would possibly come up through partnerships. Live advertising of partner's food and beverage products is what we seek to offer. It is our belief that this is the best advertisement vehicle for the fast food industry. Customers would be prompted with live advertisements at the same instant they are more than likely refilling their card.

i.e. XYZ food corporation from 2 pm-4 pm is now offering dollar double cheeseburgers in the North-Houston area.

Along with these live advertising streams there will also be other important unique incentives offered to customers. SmartCard also provides the opportunity for customers to print out hard copy of discount prices with participating stores.

The Kiosk would automatically welcome you...Hello John M. At this point, the customer would be confronted with multiple options, all laid out at the website. Customers can have their previous 3, 5, or even 10 orders remembered for easy selection. Parents can put a one day cap on the card to ensure the money is being spent for its purpose, food for their child.

In addition we seek to uniquely offer One-Button ordering. This option would allow customers to choose their favorite order with bypassing other welcome screens, thus resulting in a faster food experience.

Currently, there are multiple dealers available to choose from in regards to the P.O.S (Point Of Sale) machine itself. These machines are durable touch screens that interface software is built for. Our software will combine the option of traditional payment with the option of paying with SmartCard. Our website that combines the memory technology and software programming provides customers with a superior dining experience.

Charging your card would be from checking account only. In addition, there are other services online that would allow a smoother transition to getting your card active.

These accounts are also relayed through checking accounts and customers would have to have had a previous account with one of these institutions. i.e. PayPal Otherwise, the traditional 2-3 day verification process of checking accounts would be necessary for all cards to be initiated.

The competitive advantage of SmartCard consists of our Debit Card method. Before going any further, one must understand how credit cards eat at margins. Credit card companies charge 3% of every transaction to cover their cost related to ensuring that purchase.

With SmartCard services offered to food and beverage customers only through a debit format, our charge to these restaurants would be 1.5%. The number of credit card purchases within the fast food industry is enormous. A consolidated industry card would create savings to customers and partners.

1. SmartCard claims to be a trademarked entity 1.) seeking to transform a Point of Sale machine into the first user-friendly kiosk that through a connection to our website will offer customers the ability to quickly access their personal saved settings related to the food and beverage industry. Providing this patent allows an original idea that is not being thought of currently to come to fruition with the direction of the inventor's rights. Individuals continue to value quick reliable service. By integrating these Kiosk machines to connect with www.scsmartcard.com, customers will find a reliable debit card system designed to make their complete dining experience more desirable.
Kiosk that through our software connects to our website (The software will be a separate patent) to provide customers with their order history, live advertising, discount offers, and One-Button.ordering.
1. Storing customers order history for future client use.
2. Live advertising with time sensitive specials that can be offered anytime to anyone from retailers themselves.
3. One button ordering that customers can bypass all welcome screens to speed up their dining process even further.
